(19) United States
(12) Patent Application Publication
(10) Pub. No.: US 2010/0125614 A1
(43) Pub. Date: May 20, 2010

(54) SYSTEMS AND PROCESSES FOR FUNCTIONALLY INTERPOLATED INCREASING SEQUENCE ENCODING

(76) Inventor: Christopher Andrew D'Urso, Palo Alto, CA (US)

Correspondence Address: JONES DAY, 222 EAST 41ST ST, NEW YORK, NY, 10017, US

(21) Appl. No.: 12/271,788

(22) Filed: Nov. 14, 2008

(51) Int. Cl. G06F 17/00; G06F 7/00

(52) U.S. Cl. 707/803; 707/E17.001

(57) ABSTRACT

Systems and processes for compressing a plurality of integers are provided. The plurality of integers is accessed. Each integer in the plurality of integers references an address in a record in a plurality of records stored in computer readable memory. The plurality of plurality of integers is fit to a fitting function having a plurality of coefficients thereby establishing a value for each coefficient. A lookup table is built. The table comprises, for each of the integers, other than the first and last integer, a residual that remains when a value of the fitting function is removed from the value of the integer. A representation of the fitting function, the value for each of the one or more coefficients, and the lookup table, are stored, thereby compressing the plurality of integers.

### FIELD OF THE INVENTION

The present application is directed to systems and processes for storing large sequences of integers that have been arranged in increasing (or decreasing) order while providing for data compression (e.g., ˜5:1 compression) and direct or near direct random access.

### BACKGROUND

In 1911, Professor Lane Cooper published a concordance of William Wordsworth's poetry so that scholars could readily locate words in which they were interested. The 1,136-page tome lists all 211,000 nontrivial words in the poet's words, from Aäliza to Zutphen's, yet remarkably, it took less than seven months to construct. The task was completed so quickly because it was undertaken by a highly organized team of 67 people using three-by-five inch cards, scissors, glue, and stamps. Witten et al., 1994, Managing Gigabytes: Compressing and Indexing Documents and Images, p. 1, Van Nostrand Reinhold, New York.

In the present day, it is possible to store vast collections of documents in relatively little space and to perform full-text retrieval on such documents. Such document databases may include files that contain any combination of text, images, sound, and video. The storage of vast quantities of documents has given rise to Internet search engines, such as SEARCHME™, which, responsive to a user query, can search document databases, built by crawling Uniform Resource Locations available through the Internet, for specific documents or records relevant to the search query.

Indeed, these document databases are so large that compression techniques are often used to significantly reduce the amount of space required to store them. Many compression methods are available to compress document database. They range from numerous ad-hoc techniques to more principled methods that can give very good compression. One of the earliest and best-known methods of text compression for computer storage and telecommunications is Huffman coding, invented in the early fifties. This uses the same principle as Morse code: common symbols—conventionally, characters—are coded in just a few bits, while rare ones have longer codewords. In the late seventies—Ziv-Lempel compression and arithmetic coding (e.g., prediction by partial matching) made higher compression rates possible. Both these ideas achieve their power through the use of adaptive compression which is a kind of dynamic coding where the input is compressed relative to a mode that is constructed from the text that has just been coded. By basing the model on what has been seen so far, adaptive compression methods combine two key virtues: they are able to encode in a single pass through the input file, and are able to compress a wide variety of inputs effectively rather than being fine-tuned for one particular type of data such as English text. Early implementations of character-level Huffman coding were typically able to compress English text to about five bits per character. Ziv-Lempel methods reduce this to fewer than four bits per character. Methods based on arithmetic coding can further improve the compression to just over two bits per character.

Although the use of compression techniques discussed above can save much space, it does not help with the question of how the information should be organized so that queries can be resolved and relevant portion of the data located and extracted. Indexes, much like Professor Lane Cooper's concordance of William Wordsworth's poetry, are used for such purposes. Indexes can range in detail from a few key terms in a document, or collection of documents, to a complete concordance of every word in a document, or collection of documents, showing each context in which it was used. An alphabetically ordered index can be searched very quickly using a binary search. Each probe into the index halves the number of potential locations for the target of the search. The computer's equivalent of the concordance entry is usually too large to store in main memory, so an access to secondary storage (usually disk) is required to obtain the list of references. Then the references must be retrieved from the disk. Depending on the type of disk, how local it is to the computer, and the extent of mechanical movement that is required in devices such as jukebox arrays, this might take anything from a few milliseconds to a few seconds. Witten et al., 1994, Managing Gigabytes: Compressing and Indexing Documents and Images, Chapter 2, Van Nostrand Reinhold, New York.

A document database (document collection) can be treated as a set of separate documents, each described by a set of representative terms, or simply terms. A document index for the document database identifies documents within the document database that contain specified terms, combinations of specified terms, or other features that may be relevant to a set of query terms. A document is thus a unit of text that is returned in response to queries. The granularity of the index, the resolution to which term locations are recorded within each document, can be taken to be absolute address, to the word level, to the sentence level, to the paragraph level, or some other granularity. Moreover, the representative terms for textual documents can be deemed to be each of the words that appear in a document. Alternatively, such words can be transformed in some way before inclusion in the index (e.g., case-folding in which all words are reduced to the same case, reduction of words to morphological roots by removal of suffixes and other modifiers, and/or the omission of stop words such as “a” and “it”).

One form of index that can be used to index a document database is an inverted index. An inverted index contains, for each term in the lexicon, an inverted field entry that stores a list of pointers to all occurrences of that term, where each pointer is, in effect, the number of a document in which that term appears. The inverted field entry is also sometimes known as a posting list, and the pointers as postings. This produces a tightly packed increasing or equivalent integer sequence that can be used for the purpose of index storage and table offset values. For the purpose of table offset values the structure preferably supports direct access.

To illustrate an inverted index, consider the traditional children's nursery rhyme of Table 1, with each line taken to be a document for indexing purposes.

TABLE 1
Example text; each line is considered a document

| Document | Text |
|---|---|
| 1 | Peas porridge hot, peas porridge cold |
| 2 | Peas porridge in the pot, |
| 3 | Nine days old. |
| 4 | Some like it hot, some like it cold |
| 5 | Some like it in the pot |
| 6 | Nine days old. |

The inverted index generated from this text is shown in Table 2, where the terms have been cased-folded, but with no stemming and no words stopped. Because of the unusual nature of the example, each word appears in exactly two of the lines. This would not normally be the case, and in general, inverted field entries are of widely differing lengths.

TABLE 2
Inverted index for text of Table 1

| Number | Term | Documents |
|---|---|---|
| 1 | Cold | 1, 4 |
| 2 | Days | 3, 6 |
| 3 | Hot | 1, 4 |
| 4 | In | 2, 5 |
| 5 | It | 4, 5 |
| 6 | Like | 4, 5 |
| 7 | Nine | 3, 6 |
| 8 | Old | 3, 6 |
| 9 | Peas | 1, 2 |
| 10 | Porridge | 1, 2 |
| 11 | Pot | 2, 5 |
| 12 | Some | 4, 5 |
| 13 | The | 2, 5 |

Note that in Table 1, the first column is not necessary because it can be inferred from the row number of the inverted index. It is present merely for illustrative purposes. A query involving a single term is answered by retrieving every document that is referenced in the inverted field entry in the inverted index that corresponds to the term. For conjunctive Boolean queries of the form “term AND term AND . . . AND term,” the intersection of the terms inverted field entries is formed. For disjunction, where the operator is OR, the union is taken; and for negation using NOT, the complement is taken. As represented in the far right hand column of Table 2, the inverted field entries are typically stored in order of increasing document number, so that these various merging operations can be performed in a time that is linear in the sized of the inverted field entries. As an example, to locate documents containing “some AND hot” in the text of Table 1, the inverted field entries for the terms “some” and “hot” ( [symbol] 4, 5 [symbol] and [symbol] 1, 4 [symbol] respectively) are intersected, yielding the documents that they have in common—in this case the document [symbol] 4 [symbol] . This document is then located in Table 1, and displayed.

Uncompressed inverted indexes such as Table 2 can consume considerable space, and might occupy 50 percent to 100 percent of the space of the documents that are indexed. For example, in typical English prose the average word contains about five characters, and each word is normally followed by one or two bytes of white-space or punctuation characters. Storing the location of such words in memory as 32-bit memory addresses, and supposing that there is no duplication of words within documents, there might thus be four bytes of inverted field entry for every six bytes of text. More generally, for a text of N documents and in index containing f pointers, the total space required is f┌log N┐ bits, provided that pointers are stored in a minimal number of bits, where the notation ┌x┐ indicates the smallest integer greater than or equal to x (hence ┌3.3┐ equals 4). The omission of a set of stop words from the inverted index yields significant savings in an uncompressed inverted index, since the common terms usually account for a sizable fraction of the total word occurrences.

The size of an inverted index can be reduced considerable by compression. As noted by Table 2, such compression is based upon the observation that each inverted field entry is an ascending (or descending) sequence of integers. For example, suppose that the term elephant appears in eight documents in a document collection—documents 3, 5, 20, 21, 23, 76, 77, and 78 of the document collection. This term can be described in the inverted index by the inverted field entry:
[symbol] elephant;8;[3,5,20,21,23,76,77,78] [symbol] .
   More generally, this stores the term t, optionally, the number of documents fₜ, in which the term appears, and then a list of fₜ document numbers (the inverted field entry):
[symbol] t;fₜ;[d₁, d₂, . . . d_{f}_{ₜ}] [symbol] ,
   where dₖ<dₖ₊₁, Because the list of document numbers within each inverted field entry is in ascending order, and all processing is sequential from the beginning of the entry, the list can be stored as an initial address followed by a list of gaps, the differences dₖ₊₁−dₖ. That is, they entry for the term above could just as easily be stored as:
[symbol] elephant; 8; [3, 2, 15, 1, 2, 53, 1, 1] [symbol] .
   No information has been lost, since the original document numbers can always be obtained by calculating sums of the gaps. Considering each inverted field entry as a list of gap sizes, the sum of which can be N at most, allows improved representation, and it is possible to code inverted field entries of an inverted index using on average substantially fewer than ┌log N┐ bits per pointer. Several specific models have been proposed for describing the probability distributions of gap sizes for the purpose of improved inverted index compression. These specific models include global methods, in which every inverted field entry is compressed using the same common model, and local methods, where the compression model for each term's inverted field entry is adjusted according to some stored parameter, usually the frequency of the term. An example of a global method is to use variable-length representations of gap length in which more common gap lengths are coded with smaller codes than less common gap lengths. For example, in instances where small gap values are considered more likely than large ones the unary code can be used. In this code, an integer x≧1 is coded as x−1 one bits followed by a zero bit. For example the code for a gap of 1 is coded as 0, a gap of 2 is coded as 10, a gap of 3 is coded as 110, and a gap of four is coded as 1110. Other forms of coding include the y code, which represents the number x as a unary code for 1+└log x┘ followed by a code of └log x┘ bits that represents the value of x−2^{└log x┘} in binary, where └x┘ denotes the greatest integer less than or equal to x. The unary part specifies how many bits are required to code x, and then the binary part actually codes x in that many bits. For example, consider x=9. Then └log x┘=3, and so 4=1+3 is coded in unary code (code 1110) followed by 1=9−8 as a 3-bit number (code 001), which combine to give a codeword of 1110001. Other global methods for coding gap lengths are known. Furthermore, local methods for coding gaps, such as the local Bernoulli model, local hyperbolic model, and the local “observed frequency model” have been used for inverted file compression. See, for example Witten et al, 1994, Managing Gigabytes: Compressing and Indexing Documents and Images, Chapter 3, Van Nostrand Reinhold, New York; Bell et al., 1993, “Data Compression in Full-text Retrieval Systems,” Journal of the American Society for Information Science 44(9), 508-531.

While inverted index compression based upon the exploitation of gap lengths in inverted field entries is useful, such compression has the drawback of not providing direct access to the documents. Rather, such methods require forward sequential access. For example, to determine the value of the seventh document in the inverted field entry:
[symbol] elephant; 8; [3, 2, 15, 1, 2, 53, 1, 1] [symbol] .
   it is necessary to sum all the gap entries beginning from the start of the list of entries in the inverted field entry. Of course, the list of document numbers can be broken up into segments and the value of the starting point given for each segment so that it is not necessary to sum the gap lengths from the beginning of the list of entries. However, such a mechanism reduces the overall compression of the inverted field entries and still does not provide direct or near direct access to individual entries.

In addition to forming the basis of an inverted index as discussed above, sequences of increasing or equivalent integers find many other applications in computer science. For example, they can be used to store offsets to the start of each record in a collection of variable size records stored in memory. In fact, they can be used to store offsets to any position of interest (e.g., the address of a field within a record) in any record in a collection of records, where such records are variable or fixed in size, stored in memory.

Pointers have significant utility. For example, in the case of compressed records, since it is possible for each record to be compressed by a different amount, there is no guarantee that such records have a fixed size, even in the event that such records were of fixed size prior to compression. Therefore it is not possible to directly access such records without an associated pointer table that keeps track of the start address (or some other fixed reference address) of each record.

Offset tables used for storing offsets (pointers) to variable sized data are typically stored as simple fixed size values. As long as these offsets are small relative to the size of the data this cost is simply factored into the total cost. At the fairly typical 8-byte per record and given that variable size data records themselves are somewhat atypical, overall this expense is generally ignored. Seldom would any data records have multiple subfields also directly indexed as the additional expense is pretty high. Generally a client would unpack the entire record to obtain the data in this instance.

FIG. 1 illustrates addressing schemes in the case where uncompressed records have the same fixed size. In FIG. 1A, each record nᵢ (102) has a fixed size m. Thus, once the starting address, or some other fixed reference address, a (104-0) of the first record n₀ is known, the starting address, or some other fixed reference address, 104-i of each subsequent record i (102-i) can be directly determined as a+(nᵢ*m).

However, once the records 102 are compressed, there is no guarantee that the size of the records 102 in compressed form will be the same. Thus, referring to FIG. 1B, a pointer table 106 is needed to store a pointer (offset) 108 to the starting address, or some other fixed reference address, of each record 102. The combination of the pointer table 106 and the compressed records 102 of FIG. 1B typically occupy less space than the records of FIG. 1A. It will be appreciated that the pointer table 106 finds utility for tracking the starting address or some other fixed reference address in any record, compressed or not, that has variable size. In the case where the element size of each pointer 108 is four bytes, it is possible to directly access up to four gigabytes of memory. In other words, a pointer having a length of four bytes can address any position within a four gigabyte memory block.

The above generalizations are more or less true unless and until one considers the encoding strategies employed for data compression and packing. Here generally the outlier data values will be stored in larger byte or bit patterns so that the common data values can be stored in significantly shorter byte or bit patterns resulting in a sum gain in data efficiency. Records whose sizes would have been fixed now generally vary and direct access or near direct access require offset tables. Generally, to preserve gains achieved in encoding, a typical offset table would not be feasible and henceforth the data would lose its random accessibility for forward sequential instead. For example, consider the case where the average size of records 102 is very small in size (e.g., 2-3 bytes per record) after compression, such that there are so many offset positions (pointers) that need to be stored in the pointer table 106 that the overhead of the size of the pointer table 106 becomes prohibitive. In the case where four gigabytes of memory is filled with records that have an average size of 2-3 bytes after compression, the four byte pointer to each record completely overwhelms any possible gains that could have been made by the compression of the records.

Given the above-background, what are needed in the art are improved systems methods for compressing sequences of increasing or equivalent integers. Such improved systems and methods would find direct application in the storage of data (e.g., in the form of an inverted index, in the form of an offset table to variable length records, etc.).

### SUMMARY

The present invention addresses the drawbacks found in the known art. Processes for compressing sequences of increasing or equivalent integers (e.g., found in document indexes) are provided that afford direct or near direct access rather than requiring forward sequential access. The present invention capitalizes on the attributes of a generally increasing sequence of values (or generally decreasing sequence of values) and any predictive knowledge of how such a sequence would grow (or decrease) as a numerical function. A fitting function is derived to describe the pattern formed by the generally increasing or generally decreasing sequence of values. Function coefficients are calculated and the resulting function subtracted from each term (value) giving a residual that can be stored in a much smaller space than original sequence of values even given the overhead of the storage of the coefficients to the fitting function and packing information. Sequence values can be retrieved from the compressed data by applying the same steps in the opposite order. Advantageously, when such values are sought from the compressed data, only the coefficients of the fitting function and the residual of the term sought needs to be unpacked to return any given term. In some embodiments, the storage is direct allowing for random access of the underlying compressed data.

### BRIEF DESCRIPTION OF THE DRAWINGS

FIG. 1A illustrates a process for storing fixed length records in accordance with the prior art.

FIG. 1B illustrates a process for storing variable length records in accordance with the prior art.

FIG. 2 illustrates an exemplary computer system in accordance with an aspect of the present invention.

FIG. 3 illustrates the compression of an offset table to records, where individual records can be of variable size, in accordance with an aspect of the present invention.

FIG. 4 illustrates the compression of an offset table to records, where individual records can be of variable size, in which pointers in the offset table of records are binned prior to compression in accordance with an aspect of the present invention.

FIG. 5 illustrates an inverted index in accordance with an embodiment of the present invention. FIG. 5A illustrates the inverted index prior to compression and FIG. 5B illustrates the inverted index after compression.

FIG. 6 provides a process for compressing an inverted index in accordance with an embodiment of the present invention.

FIG. 7 illustrates a plot of sequence S and simple linear function f(x)=13/7*x+1.

FIG. 8 illustrates a computer-implemented process for compressing a pointer table comprising a plurality of pointers into a compressed data structure in accordance with an embodiment of the present invention.

Like reference numerals refer to corresponding parts throughout the several views of the drawings.

### DETAILED DESCRIPTION

The present invention capitalizes on the attributes of a generally increasing sequence of values (or generally decreasing sequence of values) and any predictive knowledge of how such a sequence would grow (or decrease) as a numerical function. A fitting function is derived to describe this pattern. Function coefficients for the fitting function are calculated and the resulting function subtracted from each term (value) giving a residual that can be stored in a much smaller space than the original term even given the overhead of the storage of the coefficients and packing information. Retrieving the sequence values is just the same steps applied in the opposite order. Note it is significant that during reading only the coefficients and the residual values sought need be unpacked to return any given term. The storage is direct allowing for random access of underlying data. The inventive systems and processes (e.g., methods) have application in a wide range of instances including but not limited to the compression of inverted file indexes and the compression of offset (pointer) tables, such as may be used with any variable sized record storage.

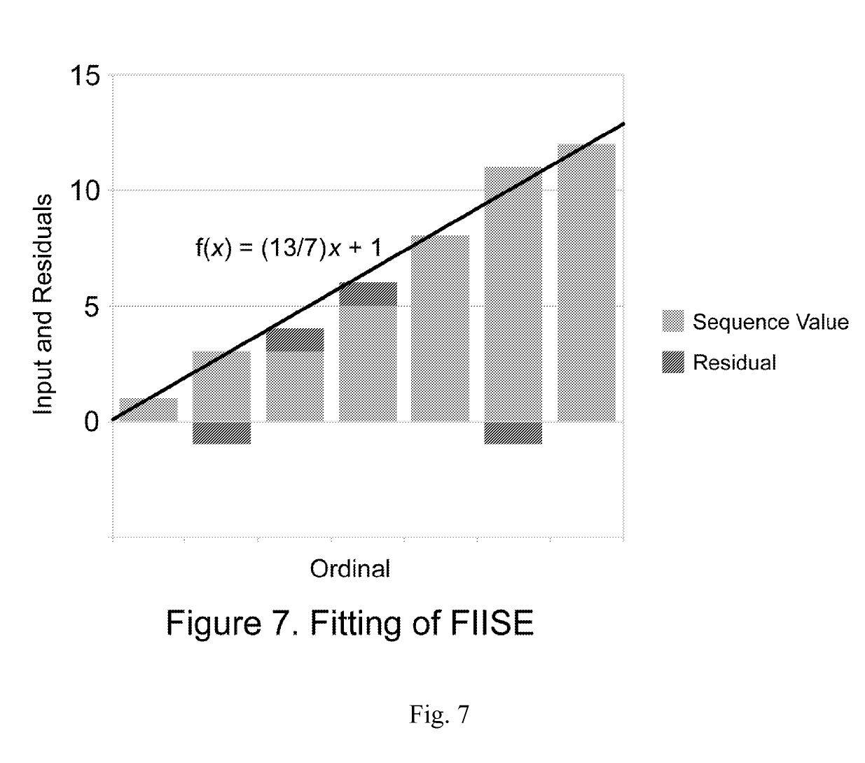

As an example of the inventive systems and processes, consider the following sequence:
S={1, 3, 3, 5, 8, 11, 12}.
   The sample sequence is first plotted against the ordinal number {(0, 1), (1, 3), (2, 3), (3, 5), (4, 8), (5, 11), (6, 12)}. Picking a function to be the first order curve f(x)=└a*(x)┘+b, the coefficients a and b are solved to be 13/7 and 1 respectively. A plot of sequence S and the linear function f(x)=13/7*x+1 is provided in FIG. 7. The value of function f(x) is subtracted from each interior point (term) x in the sequence leaving a residual. Thus, the value of each interior point is replaced with a residual. The first and last points can be determined by the equation and coefficients. In this way

S={1,3,3,5,8,11,12} becomes S′ {1,1,−1,−1,0,1,12}

For instance, term (2, 3) is stored as “−1.” To arrive at the value “−1” the function f(x) is first subtracted from the value of the term (2, 3), which is “3”, to give:

3−f(x)=3−f(2)=3−(└(13/7)*2┘+1)=3−(3+1)=−1.

The term (3, 5) is also stored as “−1.” To arrive at the value “−1” the function f(x) is first subtracted from the value of the term (3, 5), which is “5”, to give:

5−f(x)=5−f(3)=5−(└(13/7)*3┘+1)=5−(5+1)=−1

The term (4, 8) is stored as “0.” To arrive at the value “0” the function f(x) is first subtracted from the value of the term (4, 8), which is “8”, to give:

8−f(x)=8−f(4)=8−(└(13/7)*4┘+1)=8−(7+1)=0

Note that the magnitude of the interior values becomes much smaller. In this case, by using a first order curve f(x)=a*(x)+b the first and last data point match by definition hence are stored indirectly.

Next the sequence of terms can be compacted. In the example of seven terms given above, the first and last values can be stored in a 4 bit unsigned integer and each of the 5 interior values can be stored as a 2 bit signed integer. The total cost is 18 bits. The uncompressed version, which would take 4 bits per number multiplied by 7 numbers, is 24 bits. Even in this small example, the compression comes out ahead, a subset of 256 values with real world index data results in a better performance and typically compresses at the rate of 5:1.

In practice, there are two factors that can be addressed in order to optimize the compression of the values. The first factor is the choice of fitting function. The second factor is the determination of whether to break the list of entries to be compressed into intervals, where each interval has its own refined coefficients for the fitting function. These two factors are independent of each other and can be separately optimized. In one approach an optimal fitting function for a given list of entries is determined and then this fitting function is used to empirically test different interval sizes to identify the best interval.

Several different fitting functions can be tested to see if they are suitable for minimizing the size of the residuals of the list of entries. Such fitting functions include, but are not limited to, monomial and polynomial functions (e.g., binomial functions, quadratic functions, trinomial function, etc.) of any degree greater than zero (e.g., the linear function f(x)=a*(x)+b given above where the value └a*(x)┘ is taken for a*(x)), rational functions

$$( e . g . , R ( x ) = \frac{{a}_{n} {x}^{n} + {a}_{n - 1} {x}^{n - 1} + … + {a}_{1} x + {a}_{o}}{{b}_{n} {x}^{n} + {b}_{n - 1} {x}^{n - 1} + … + {b}_{1} x + {b}_{o}} ) ,$$

exponential functions (e.g., exponential decay or exponential growth), power functions (e.g., f(x)=ax^{p}, where a and p are real numbers), power series (e.g., a power series on variable x), or any combination thereof. For instance, in the example given above, a simple first order curve was deemed to be the best fitting function. This may be useful if the gap interval between entries in the list of entries is fairly uniform. For example, consider the case where the list of entries represents the document identifiers for those documents in a document library that contain the word “elephant.” If the documents that contain the word “elephant” are arranged in ascending document identifier order, and the frequency with which the word “elephant” appears in documents in the document library is more or less constant than the simple first order curve is a suitable fitting function. Consider, however, a document library that was sorted by document size, largest to smallest, before the document identifiers were assigned to the documents in the library. In such a set, the larger documents by virtue of their larger size would more likely contain any given word, such as “elephant.” So, in such instances, if the documents that contain the word “elephant” are arranged in ascending document identifier order, the frequency with which the word “elephant” appears in documents in the document library will not be constant. The list of entries will be overrepresented for document identifiers with low numbers, representing the large documents in this example, and underrepresented for document identifiers with high numbers, representing the small documents in this example, because the large documents are more likely to contain the word “elephant” and therefore be represented in the list of entries. In this instance, a fitting function that is an exponential decay may account for this variability in the list of entries and provide a better fit to the sequence of document identifiers, thereby requiring smaller residuals to be stored and hence less over all storage.

In practice, for large datasets, a single interval may not produce optimal compression. In such instances, the list of entries can be broken up into intervals, with each interval receiving its own fitting function coefficients. For instance, consider the case where the list of entries to be compressed is broken into intervals [0, n/2) and [n/2, n) where n is the number of entries and the fitting function f(x)=ax+b. In this case, the list of entries in the interval [0, n/2) would be used to obtain coefficients a and b for the fitting function and, separately, the list of entries in the interval [n/2, n) would be used to obtain coefficients a′ and b′ for the fitting function. As this case suggests, typically, the same fitting function is used for each of the intervals in the list of entries and this fitting function is refined against each interval. Thus, each interval has the same form of fitting function (e.g., a linear function) but possibly different, independent, values for the coefficients to the fitting function.

In one approach, the best fitting function for the entire list of entries is identified and the amount of compression achieved by this formula noted. That is, the compression ratio achieved is noted. As used herein, a compression ratio is a ratio between the number of bits required to represent the data (here, the entire list of entries) before compression to the number of bits required to represent the data after compression. Typically, the list of entries to be compressed is very large. Thus, rather than sampling different fitting functions against all of the entries to be compressed, the fitting functions are tested against a representative sampling of the full list of entries. The list of entries is then divided into halves and separate coefficients to the fitting function are obtained for both halves of the list of entries. If the compression ratio upon dividing the list of entries into two intervals is better than using a single fitting function, the process continues by then dividing the list of entries into three intervals, identifying suitable coefficients to the fitting function for each of the three intervals and computing a compression ratio after the list of entries has been compressed, on an interval by interval basis, using the three separate sets of coefficients. The list of entries is divided into successfully greater number of intervals until no improvement in the compression ratio is found. The function coefficients for each of the intervals is then stored.

The list of entries considered in the present application is often very large (e.g., more than 100 entries, more than one thousand entries, more than one million entries, more than 1 billion entries, etc.) and, as indicated by the process set forth above, many different computations need to be run in order to find the optimal fitting function, intervals, and coefficients. If the list of entries is large and is used in its entirety to find the optimal fitting function, interval size, and coefficients, a significant amount of computation would need to be performed. To reduce the computational expense, in some embodiments two or more representative samplings of the full list of entries are independently selected and the above-described approach of finding the best fitting function, empirically deriving the best interval size, and then determining optimal coefficients to the fitting function for each interval is independently run on each of the two or more representative samplings. If the same fitting function, similar interval sizes, and similar coefficient values are obtained for each of the two or more representative samplings, the fitting function, interval size, and coefficients of one of the two or more representative samplings is accepted for the full list of entries.

In some embodiments, different fitting functions are sampled for each interval before refining coefficients. For example, in some embodiments, an exponential fitting function and a polynomial fitting function are tested on each interval of the list of entries. Thus, it is possible that one interval within the list of entries is described by a polynomial fitting function and another interval within the list of entries is described by an exponential function. More typically, each interval of a list of entries has the same form of fitting function (e.g., a linear function) with different coefficients since it is not expected that the data will adopt very different behavior in each of the different intervals.

In the case where one wishes to determine if a particular value is present in a list of entries that has been compressed into fixed intervals, a quick calculation of which interval the entry would be in, if present, is made and then the coefficients for the fitting function of that interval are unpacked. For example, consider the case where the data has been divided into two intervals [0, n/2) and [n/2, n) where n is the number of entries in the list of entries. If one wishes to determine whether m is in the list of entries, one determines whether m is in the first or second interval by asking the question whether m is less than n/2. If so, the coefficients to the first interval, [0, n/2), are unpacked and used to determine whether m is in the first interval. If not, then the coefficients to the second interval, [n/2, n), are unpacked and used to determine whether m is in the second interval. More generally, if the list of entries of n entries is divided into p equal intervals, one looks at the interval

$$⌈ p \cdot \frac{m}{n} ⌉$$

(where the first interval is referenced as interval 1 and the last interval is referenced as interval p) to determine whether the entry is in that interval. If it is not in that interval, it is not in the list of entries. Such bisecting or binary search results in an average search path of log(n) evaluations in order to locate an entry or indicate that the entry is not an element in the sequence. Further, once a search has resulted in locating a value in the sequence the position i can be utilized to store ancillary data, such as with posting lists data specific to the term XDocIDy.

An example where a list of entries is divided into fixed length intervals is instructive. In this example a common term present in 1.2 million documents of a 2 million documents collection is considered. Here, the document identifier for each document in the 1.2 million documents is in the list of entries. The 0.8 million documents that do not have the common term are not in the list of entries. Thus, the 1.2 million document identifiers for the 1.2 million documents can be sorted in ascending order and qualify as large sequence of increasing integers suitable for compression using the systems and processes of the present invention. After some sampling, it is determined that a linear function can be used for the fitting function with two coefficients, f(x)=ax b, with sectional binning of 256-entry intervals. This binning, chosen with brief experimentation minimized the residual magnitude hence the overall efficiency while adding only one level of indirection. Thus, each of the roughly five thousand 256-entry intervals has different coefficients a and b to the linear function. For each bin, in addition to storing functional coefficients a and b, additional information for packing and unpacking, the coefficients and residual bit depth are determined and stored as well along with the residual data. When complete, the aggregate cost of sequential entry in this example is 6.01 bits on par or exceeding other encoding techniques, which generally do not provide direct access. In order to access any data point one must only (1) calculate the bin offset for that point, (2) unpack the bins functional coefficients, and in the case of the data point being the first or last of the subset, the process is complete, else in the common case, (3) retrieve the residual offset and calculate the sequential value. Advantageously, no other coefficient blocks, no previous sequential value, and no previous residual value needed to be accessed.

So far simple fixed size (linear) binning approaches to obtain high compressibility of a list of entries have been described. The altering of the bin size as set forth above provides one level of optimization that can be tested. Likewise, given that storing functional coefficients and keeping track of subsection offsets take space, an automated and non-linear approach could be applied to the search for the best functionally interpolated increasing sequence encoding for a particular dataset, given very simple boundary conditions. An example of one such non-linear bifurcation approach is to first create a single bin covering all n entries in the list of entries and compute the size necessary to store such an encoding. Second, the first functional coefficients are used to refine the function coefficients for the two intervals [0, n/2) and [n/2, n). If either interval takes less space than corresponding parents' residual allowance then it deemed to be a candidate for further branching. Otherwise, the fitting function for the parent stands as the fitting function for the interval. For every surviving branch the approach may be repeated giving an opportunity to quickly settle on a bin-wise optimal solution, of depth or levels in a potentially complex tree structure. This approach would generally lead to intervals that are not the same size. For example, consider the case where the corresponding parents' residual allowance for [0, n/2) is better than the residual computed on the interval [0, n/2) whereas the corresponding parents' residual allowance for [n/2, n) is not as good as the residual computed on the interval [n/2, n). In this case, interval [0, n/2) is not a candidate for further branching whereas the interval [n/2, n) is a candidate for further branching. Suppose further that the interval [n/2, n) is broken up into the intervals [n/2, n3/4) and [n3/4, n) and the residual computed on the each of these intervals is better than the residual computed on [n/2, n). In this instance, the list of entries is divided into the unequal intervals [0, n/2), [n/2, n3/4), and [n3/4, n).

In the case where one wishes to determine if a particular value is present in a list of entries that has been compressed into uneven intervals, a binary search is performed to determine which interval the entry would be in, if present, and then the coefficients for the fitting function of that interval are unpacked. For example, consider the case where the data has been divided into the list of entries is divided into the unequal intervals [0, n/2), [n/2, n3/4), and [n3/4, n) where n is the number of entries. In the binary search, if one wishes to determine whether m is in this list of entries, one first asks whether m is less than n/2. If so, the coefficients to the first interval, [0, n/2), are unpacked and used to determine whether m is in the first interval. If not, one asks whether m is less than n3/4. If so, the coefficients to the second interval, [n/2, n3/4), are unpacked and used to determine whether m is in the second interval. If not, the coefficients to the third interval, [n3/4, n), are unpacked and used to determine whether m is in the third interval. In this example, in the case where m is less than n/2, a single binary decision needs to be made before a direct access to m in the list of entries can be made. And, in the case where m is greater than n/2, two binary decisions need to be performed before a direct access to m in the list of entries can be made.

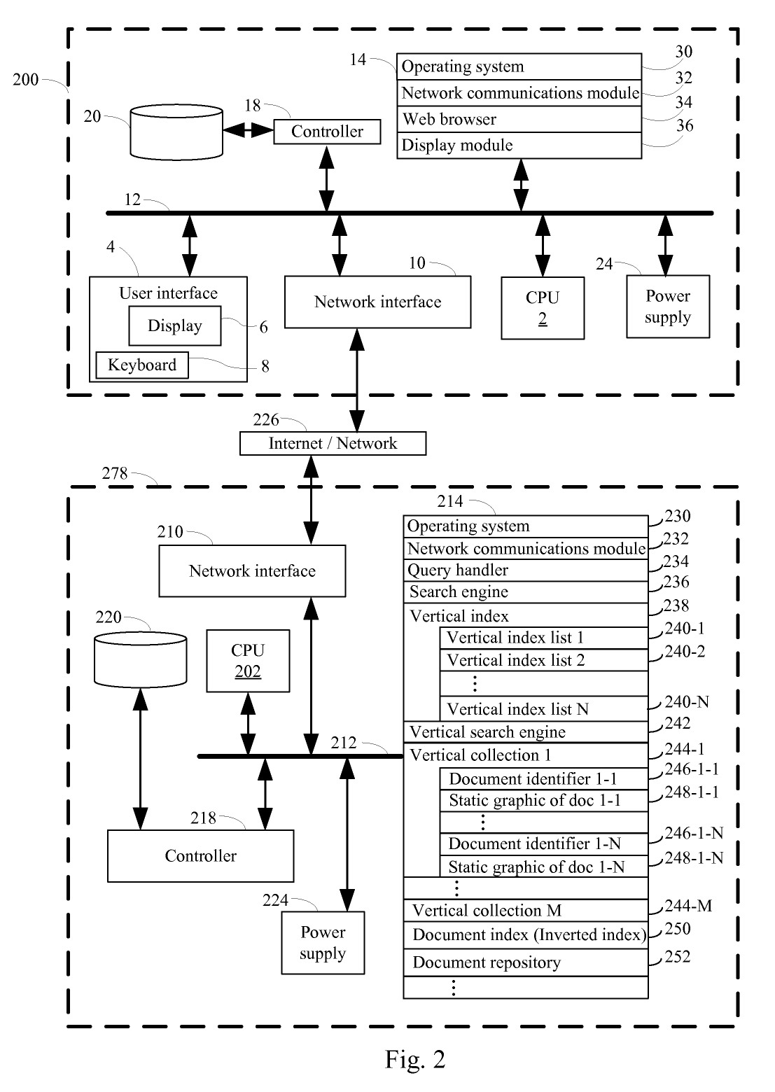

Now that an overview of the novel compression techniques and their advantages have been provided, a more detailed description of a system in accordance with the present application is described in conjunction with FIG. 2. The computer system of FIG. 2 includes an inverted index. It will be appreciated that other computer systems are envisioned than include pointer tables or other data structures that include generally increasing or decreasing sets of integers that can be compressed in accordance with the present invention. Thus, the present invention is not limited to the compression of inverted indices.

In some embodiments, computer system 278 of FIG. 2 is implemented using one or more computers instead of just the single computer illustrated in FIG. 2 for computer system 278. Computer system 278 will typically have one or more processing units (CPUs) 202, a network or other communications interface 210, a memory 214, one or more nonvolatile storage devices 220 accessed by one or more controllers 218, one or more communication busses 212 for interconnecting the aforementioned components, and a power supply 224 for powering the aforementioned components. Data in memory 214 can be seamlessly shared with non-volatile memory 220 using known computing techniques such as caching. Memory 214 and/or memory 220 can include mass storage that is remotely located with respect to the central processing unit(s) 202. In other words, some data stored in memory 214 and/or memory 220 may in fact be hosted on computers that are external to vertical search engine 278 but that can be electronically accessed by computer system 278 over an Internet, intranet, or other form of network or electronic cable (illustrated as element 226 in FIG. 2 in the form of the offsets of multiple fields within a record) using network interface 210.

Memory 214 optionally stores:
an operating system 230 that includes procedures for handling various basic system services and for performing hardware dependent tasks;
a network communication module 232 that is used for connecting computer system 278 to various client computers such as client computers 200 (FIG. 2) and possibly to other servers or computers via one or more communication networks, such as the Internet, other wide area networks, local area networks (e.g., a local wireless network can connect the client computers 200 to computer system 278), metropolitan area networks, and so on;
a query handler 234 for receiving a search query from a client computer 200;
a search engine 236 for searching either a selected optional vertical collection 244, a document index 250, where document index 250 can, for example, represent the entire Internet or an intranet, for documents related to a search query and for forming a group of ranked documents that are related to the search query;
an optional vertical index 238 comprising a plurality of vertical indexes 240, where each vertical index is an index of a corresponding vertical collection 244;
an optional vertical search engine 242, for searching optional vertical index 238 for one or more vertical index lists 240 that are relevant to a given search query;
an optional plurality of vertical collections 244, each optional vertical collection 244 comprising a plurality of document identifiers 246 and, optionally, for each respective document identifier 246, a static graphic representation 248 of the source URL for the document represented by the respective document identifier 246;
a document index 250 comprising a list of terms, a document identifier uniquely identifying each document associated with terms in the list of terms, and the sources of these documents; and
a document repository 252 comprising a source URL or a reference to a source URL for each document in the document repository and, optionally, a static graphic representation of the source URL for each document in the document repository.

Computer system 278 is optionally connected via Internet/network 226 to one or more client devices 200. FIG. 2 illustrates the connection to only one such client device 200. However, in practice, computer system 278 can be connected to any number of client devices 200. In typical embodiments, a client device 200 comprises:
one or more processing units (CPUs) 2;
a network or other communications interface 10;
a memory 14;
optionally, one or more nonvolatile storage devices 20 accessed by one or more optional controllers 18;
a user interface 4, the user interface 4 including a display 6 and a keyboard or other input device 8;
one or more communication busses 12 for interconnecting the aforementioned components; and
a power supply 24 for powering the aforementioned components.

In some embodiments, data in memory 14 can be seamlessly shared with non-volatile memory 20 using known computing techniques such as caching. In some embodiments the client device 200 does not have a nonvolatile storage device. For instance, in some embodiments, the client device 200 is a portable handheld computing device and network interface 10 communicates with Internet/network 226 by wireless means.

Memory 14 preferably stores:
an operating system 30 that includes procedures for handling various basic system services and for performing hardware dependent tasks;
a network communication module 32 that is used for connecting client device 100 to computer system 278;
a web browser 34 for receiving a search query from client computer 100; and
a display module 36 for instructing the web browser 34 on how to display search results relevant to a submitted search query.

In some embodiments, a document index 250 is constructed by scanning documents on the Internet and/or intranet for relevant search terms. An exemplary document index 250 is illustrated below:

| Term | Document Identifier |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, the document index 250 is constructed by conventional indexing techniques. Exemplary indexing techniques are disclosed in, for example, United States Patent publication 20060031195, which is hereby incorporated by reference herein in its entirety. By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and/or (iv) a number of times the document is referenced by other documents. High scoring documents are associated with the term. In preferred embodiments, document index 150 stores the list of terms, a document identifier uniquely identifying each document associated with terms in the list of terms and, optionally, the scores of these documents. In some embodiments, the document identifier uniquely identifying each document is a uniform resource location (URL) or a value or number that represents a uniform resource location (URL). Those of skill in the art will appreciate that there are numerous methods for associating terms with documents in order to build document index 250 and all such methods can be used to construct document index 250.

There is no limit to the number of terms that may be present in document index 250. Moreover, there is no limit on the number of documents that can be associated with each term in document index 250. For example, in some embodiments, between zero and 100 documents are associated with a search term, between zero and 1000 documents are associated with a search term, between zero and 10,000 documents are associated with a search term, or more than 10,000 documents are associated with a search term within document index 250. Moreover, there is no limit to the number of search terms to which a given document can be associated. For example, in some embodiments, a given document is associated with between zero and 10 search terms, between zero and 100 search terms, between zero and 1000 search terms, between zero and 10,000 search terms, or more than 10,000 search terms.

In the context of this application, documents are understood to be any type of media that can be indexed and retrieved by a search engine. A document may code for one or more web pages as appropriate to its content and type. Many documents can be indexed. For instance, more than one hundred thousand documents, more than one million documents, more than one billion documents, or even more than one trillion documents can be represented by document index 250. In some embodiments, each document is a record.

In some embodiments, for each document referenced by document index 250, computer system 278 stores or can electronically retrieve (i) the source document or a document identifier 246 (document reference) that can be used to retrieve the source document and optionally a static graphic representation 248 of the source document. In some embodiments, the document identifier 246 is stored in document index 250 while the static graphic representations 248 of the source documents are stored in document repository 252. In some embodiments, the document identifier 246 and the static graphic representation 148 of each source document tracked by computer system 278 is stored in document index 250. In some embodiments, the document identifier 246 and the static graphic representation 248 of each source document tracked by the computer system 278 is stored in document repository 252. It will be appreciated that document identifiers 246 and static graphic representations 248 may be stored in any number of different ways, either in the same data structure or in different data structures within computer system 278 or in computer readable memory or media that is accessible to computer system 278.

In some embodiments each static graphic representation of a document is a bitmapped or pixmapped image of a web page encoded by the code in the corresponding document. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

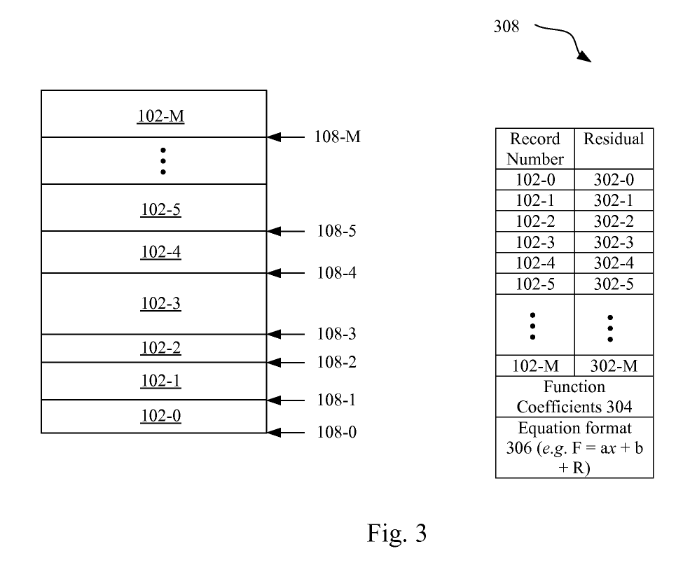

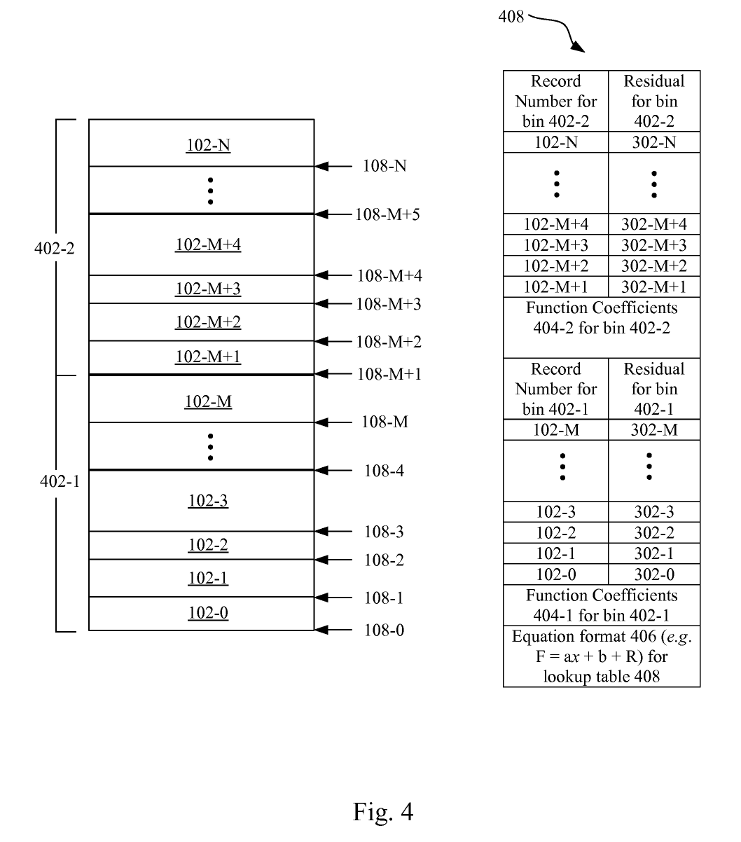

The computer system 278 of FIG. 2 is an example of a search engine. Examples of the application of the inventive systems and processes to compress offset tables (pointer tables) to records, where individual records can be of variable size, will now be described in conjunction with FIGS. 3 and 4. Such offset tables can be used by search engines as well as in many other applications.

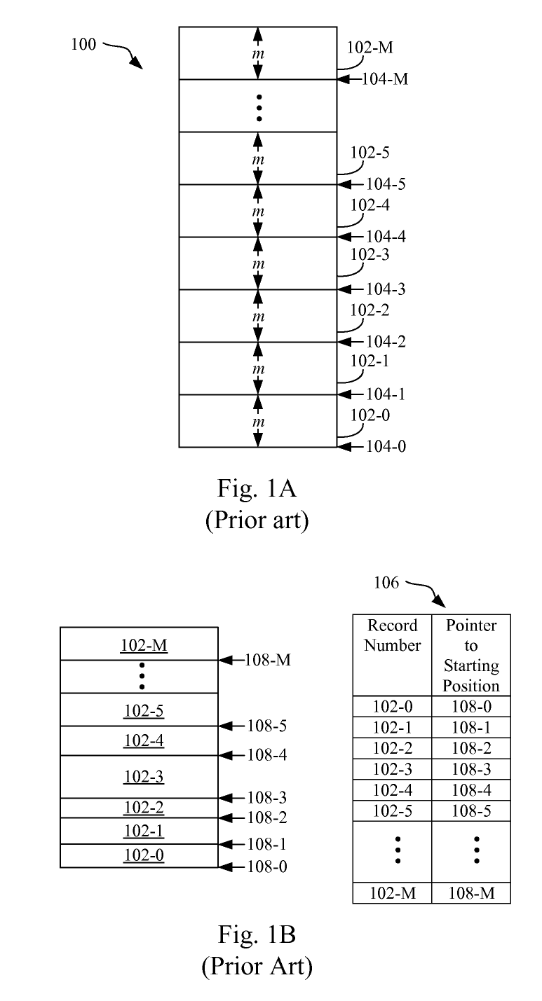

As discussed in the background in conjunction with FIG. 1B, in the case where the average size of records 102 is small in size (e.g., 2-3 bytes per record) after compression, such that there are so many offset positions that need to be stored in the pointer table 106 that the overhead of the size of the pointer table 106 becomes prohibitive. In the case where four gigabytes of memory is filled with records that have an average size of 2-3 bytes after compression, the four byte pointer to each record overwhelms any possible gains that could have been made by the compression. The present invention addresses this drawback by replacing absolute address values of individual pointers in the pointer table with an equation that describes an ascending or descending trend in the in the absolute address values of the pointers 108 in the pointer table 106. Thus, referring to FIG. 3, rather than storing fixed length pointers 108, the lookup table 308 stores function coefficients and residuals 302, which occupy considerably less space than the fixed length addresses of pointers 108. In order to obtain a starting address 108 for a record 102, the function coefficients 304, the residual 302 that corresponds to the record 102 in the lookup table 308, and the equation format 306 are unpacked from the lookup table 308 and the equation 306 solved for starting address 108. Lookup table 308 can be stored in, for example a memory 220 or 214 of FIG. 2. To illustrate, consider the case where the equation 306 has the format F=ax+b+R, where F is the desired address 108, coefficients a and b are stored as elements 304, and R is the corresponding residual 302 in the lookup table 308. If one desires address 108-3, then x is 3 and all information necessary to solve equation 306 (a, b, and R) can be unpacked from lookup table 308. In lookup table 308, there is a record number column and a separate residual column. However, if the residuals are stored in the same order as the pointers in the ordered list of pointers that the residuals replace, there is no need to store record numbers. The record number can be inferred from the residual number. For example, if lookup table 308 stores exactly one residual for each record 102, than residual 302-2 would correspond to an address in the record 102-2 in memory.

It will be appreciated that, exactly as in the case of the inverted index examples given above, any form of simple fixed size (linear) binning or variable size binning can be used to bin the pointers 108 into bins. In such instances, the ascending or descending trend in the absolute values of the addresses stored by pointers 108 in a respective bin are used to refine the function coefficients 304 of the respective bin and the residuals 302 are stored in the lookup table. To illustrate, FIG. 4 provides a lookup table 408 for records 102 that have been separated into bins 402 and then the full addresses referenced by pointers 108 for each of the records in each bin 402 have been reduced to residuals. As illustrated in FIG. 4, each bin 402 has its own coefficients 404 and there is a single equation format 406 that is used by each bin 402 in the lookup table 408. It is possible for the size of each of the bins 402 to be the same or different. Furthermore, as discussed above in conjunction with inverted indices, it is possible for the same or different equation format to be used for each of the bins 402. In the case where a different equation format is used for respective bins 402 in a single lookup table 408, each of the equation formats and which bins they are applicable to are stored. In lookup table 408, there is a record number column and a residual column. However, if the residuals are stored in the same order as the pointers in the ordered list of pointers that the residuals replace, there is no need to store record numbers. The record numbers can be inferred from the residual numbers. For example, if the lookup table 408 stores exactly one residual for each record 102, than residual 302-M+4 would correspond to an address in the record 102-M+4 in memory.

The above examples of lookup tables store the start address of each record stored in addressable memory in lookup tables using functions and residuals rather than absolute fixed values thereby achieving substantial memory savings. However, it is possible to expand beyond just the starting reference of each such record. Pointers can be used to point to the first letter in each word in the records, the first verb in every sentence in the records, or any form of subset of any form of record. In all of these cases, the pointers to such addresses within the records can be ordered as an increasing list of addresses in which not all addresses are present. Such pointers can be compressed using the systems and processes of the present invention to a function and residuals so that the pointers occupy less space.

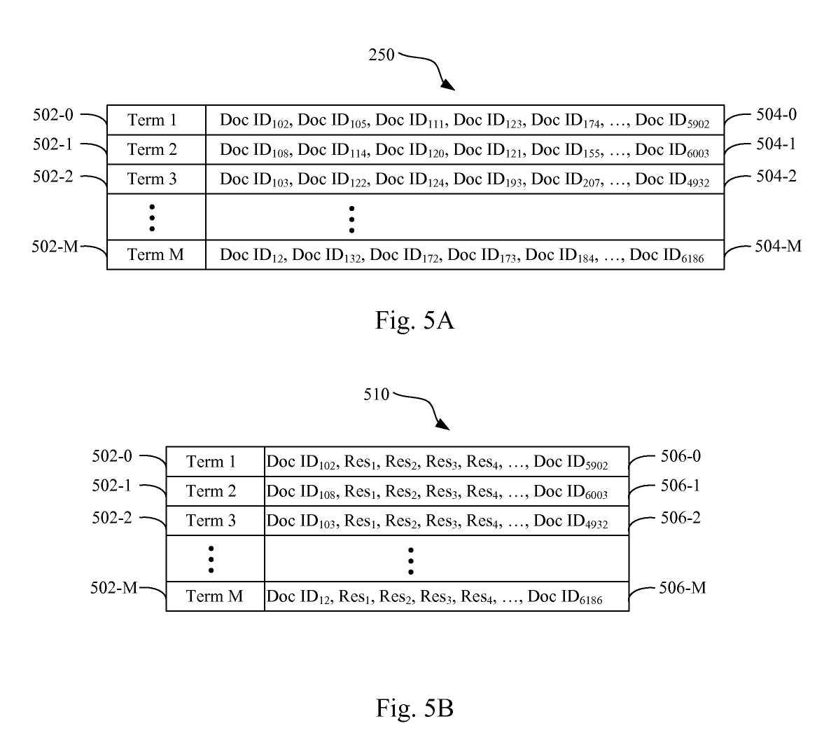

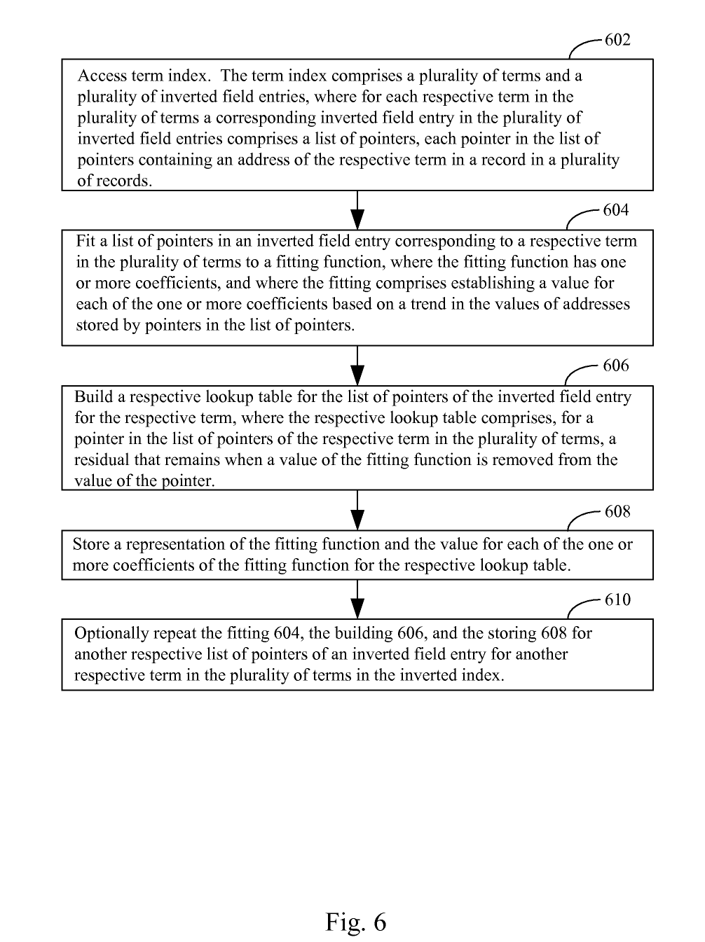

An example of processes for compressing an inverted index (e.g., term index) will now be described in conjunction with FIGS. 5 and 6. In step 602 of FIG. 6, an term index is accessed. In some embodiments this requires, for example, retrieving the inverted index from a random access memory or nonvolatile memory located on a local or remote computer. In this example, the inverted index comprises a plurality of terms 502 and a plurality of inverted indices, where for each respective term in the plurality of terms a corresponding inverted field entry 504 in the plurality of inverted field entries comprises a list of pointers 504, each pointer in the list of pointers 504 containing an address of the respective term in a record in a plurality of records, where each pointer in the list of pointers 504 is arranged (i) in order of generally increasing value or (ii) in order of generally decreasing value. An example of a term is the word “elephant.” If term 502-0 in the inverted index stores the word “elephant” the corresponding inverted field entry 504-0 stores the address of each instance of the word “elephant” in a plurality of records. This plurality of records can be, for example, individual documents, or portions of documents, that have been obtained from a crawl of the Internet. Each Doc ID in a list of pointers is a pointer that stores a particular address in a particular record (e.g., document) in a plurality of records. There may be several instances of the term (e.g., the word “elephant” in the example given) in a single record. In such instances, each instance of the term in the single record can be provided as a pointer (Doc ID) in ascending or descending order in the list of pointers 504. Alternatively, in some embodiments, only instances of the term in the first predetermined number of kilobytes (e.g. first 100 kilobytes) of the record are posted in the list of pointers 504. It will be appreciated that many other schemes can be used. In some embodiments, a term is deemed to be the presence of a feature in a document and each pointer in the list of pointers in the inverted field entry 504 corresponding to the term is an address of a record that contains this feature. This feature can be a characterization of a record as a whole, in which case there is, at most, a single pointer to any given record in an inverted field entry, or the feature may be a specific attribute that can occur many times in a single record in which case there can be a plurality of pointers to various locations in a given record in a given inverted field entry 504. An example of a characterization of a record as whole is the case where the category is a document category such as “electronics.” In this example, each pointer in the list of pointers in the inverted field entry 504 that corresponds to this category are those documents (records) in a plurality of documents that have been categorized as “electronics” documents. The characterization of documents (e.g., the characterization of documents into vertical collections) is described, for example, in U.S. patent application Ser. Nos. 11/404,687, filed Apr. 13, 2006, 11/404,620, filed Apr. 13, 2006, 11/542,581, filed Oct. 3, 2006, 11/983,629, filed Nov. 8, 2008, 12/045,685, filed Mar. 10, 2008, 12/045,691, filed Mar. 10, 2008, 12/045,696, filed Mar. 10, 2008, and 12/131,087 filed May 31, 2008, each of which is hereby incorporated by reference herein in its entirety for such purpose. An example of a specific attribute that can occur many times in a singe record is the <Bold> tag in HTML. In this example, each pointer in the list of pointers in an inverted field entry 504 that corresponds to this specific attribute stores the address of an instance of the <Bold> tag in a record in the plurality of records.

In step 604 a list of pointers in an inverted field entry 504 for a respective term 502 in the plurality of terms is fitted to a fitting function. Each inverted field 504 entry comprises a list of pointers. Thus, in step 604, the fixed addresses stored by the pointers in the list of pointers 504 for the selected term 502 are fitted to a fitting function. As described above, the fitting function has one or more coefficients. This fitting process comprises establishing a value for each of the one or more coefficients. In some embodiments, the fitting comprises evaluating a plurality of fitting functions using a subset of the list of pointers of the inverted field entry 504, where the fitting function in the plurality of fitting functions that achieves the most compression of the subset of pointers is deemed to be the fitting function for the entire list of pointers in the inverted field entry 504. In some embodiments, the fitting function is a monomial function, a polynomial function, a rational function, a power function, a power series, or any combination thereof.

In step 606, a lookup table 506 for the list of pointers of the inverted field entry 504 for the respective term in the last instance of step 604 is built. This lookup table comprises, for a pointer in the list of pointers in the inverted field entry 504 for the respective term in the plurality of terms, a residual that remains when a value of the fitting function is removed from the value of the address stored by the pointer. For example, consider the case where the term is term 502-0 and the pointer Doc ID₁₀₅ is a pointer in the list of pointers of the inverted field entry 504-0 that corresponds to term 502-0. In step 606, the value of the fitting function solved for position 105, f(105), is removed from the address stored by Doc ID₁₀₅ to provide the residual Res₁ in the lookup table 506-0. Thus, to build the lookup table 506 for the list of pointers in the inverted field entry 504 that corresponds to the term 502, the address stored by the pointer Doc ID₁₀₅ is replaced by Res₁. In some embodiments, the lookup table 506 has the same format as the list of pointers of the inverted field entry 504 with the exception that the addresses stored by all interior pointers in the list of pointers are replaced by residuals. Interior pointers are all pointers in the list of pointers 504 other than the first pointer and the last pointer.

In step 608 a representation of the fitting function and the value for each of the one or more coefficients of the fitting function for the respective lookup table 506 are stored. An exemplary representation of a fitting function can be a scheme in which there is a one byte code, where each possible value for the byte represents a different function type. In some embodiments, less memory is used to represent the various possible function types. In some embodiments, two or three bits are reserved to indicate the possible function types. For example, in the case where two bits are reserved, “00” can represent the function f(x)=a*(x)+b, “01” can represent the function f(x)=a*(x)²+b*(x)+c, “10” can represent the function f(x)=a*(x)³+b*(x)²+c*(x)+d, and “11” can represent the function f(x)=a*(x)⁴+b*(x)³+c*(x)²+d*(x)+e. In some embodiments, the same fitting function is always used and only the coefficients to the fitting function are refined. In such embodiments, there is no need to store a representation of the fitting function.

In step 610 the fitting 604, the building 606, and the storing 608 are repeated for another list of pointers of an inverted field entry 504 for another respective term in the plurality of terms. In this way, each of the list of pointers 504 of FIG. 5A is converted to a lookup table 506 in the data structure 510 of FIG. 5B. Advantageously, the lookup tables 506 occupy considerably less space than the corresponding inverted field entry 504 because the lookup tables contain residuals to addresses to specific locations in a plurality of records, rather than the full absolute addresses to such locations.

In some embodiments, the fitting of step 604 comprises segmenting the list of pointers 504 into a plurality of intervals, where each interval in the plurality of intervals has independent values for the one or more coefficients of the fitting function. In such embodiments, the storing 608 further comprises storing the value for each of the one or more coefficients for each interval in the plurality of intervals.

The records described herein can be any form of records. In typical embodiments such records can be compressed. Such records can be database records. Such records can be XML records or records written in some other markup language, where the records each have a beginning and an end as well as a plurality of fields, each with a beginning and an end. Advantageously, the addresses of the start and end of such records, and the addresses of the start and end of each of the fields within the records can be indexed into pointer tables so that the records do not have to be read and parsed at a later date. For example, consider the case in which it is desired to track the start address of each <title> field in a collection of HTML documents as well as the start address of each <body> field in the collection of HTML documents. In such a case, three pointer tables could be constructed for the collection of HTML documents, the first pointer table for the start address of each of the HTML documents, the second pointer table for the start address of each of the <title> fields in each of the HTML documents in the collection of HTML documents, and the third pointer table for the start address of each of the <body> fields in each of the HTML documents in the collection of HTML documents. The pointers in all three separate pointer tables can be optionally binned so that each of the separate pointer tables includes bins, each bin of pointers fit to a fitting function, and the pointer tables replaced by packed function coefficients together with the residuals to each of the corresponding pointers in order to save space.

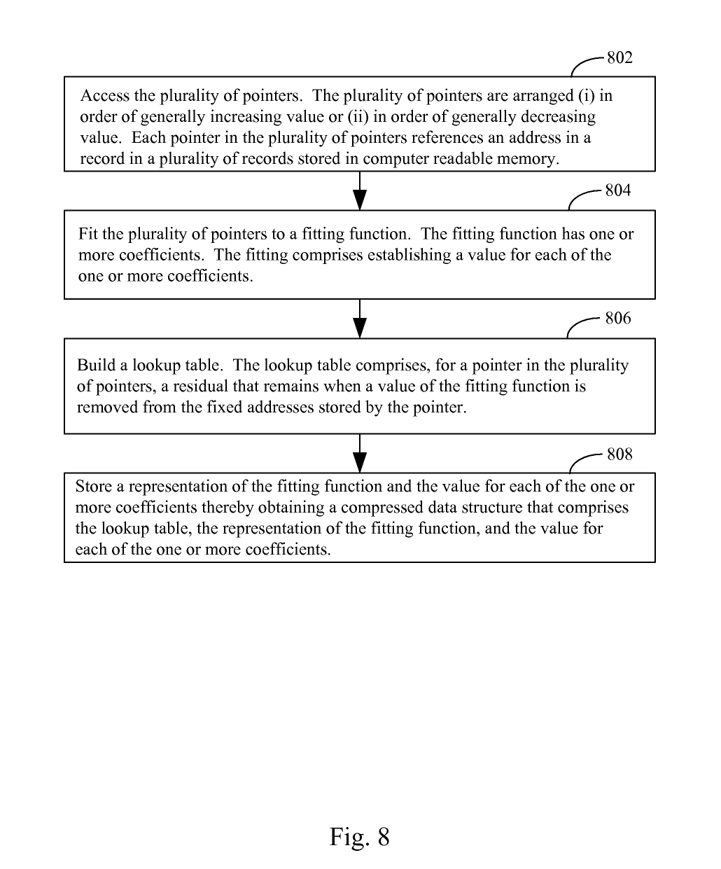

Referring to FIG. 8, a computer-implemented process for compressing a pointer table comprising a plurality of pointers into a compressed data structure is provided. In step 802 the pointer table comprising the plurality of pointers is accessed. The plurality of pointers are arranged (i) in order of generally increasing value or (ii) in order of generally decreasing value. Each pointer in the plurality of pointers references an address in a record in a plurality of records stored in computer readable memory. In step 804, the plurality of pointers is fit to a fitting function. The fitting function has one or more coefficients. The fitting comprises establishing a value for each of the one or more coefficients. In step 806, a lookup table is built. The lookup table comprises, for a pointer in the plurality of pointers, a residual that remains when a value of the fitting function is removed from the value of the pointer. Typically, the lookup table comprises a residual for each pointer in the plurality of pointers other than the first pointer and the last pointer. Each respective residual is built by subtracting the value of the function for a corresponding pointer from the pointer itself.

In step 808 a representation of the fitting function and the value for each of the one or more coefficients is stored thereby obtaining a compressed data structure that comprises the lookup table, the representation of the fitting function, and the value for each of the one or more coefficients. In some embodiments the compressed data structure in fact is a plurality of data structures. For example, in some embodiments, the fitting function and the value for each of the one or more coefficients are stored in a first data structure whereas the lookup table is stored in a second data structure. In such instances, the compressed data structure is deemed to be both the first and the second data structure, collectively. It will be appreciated that the compressed pointer list can be stored in any number of data structures that can collectively be referenced as the compressed data structure.

### CONCLUSION AND REFERENCES CITED

The present invention can be implemented as a computer program product that comprises a computer program mechanism embedded in a computer readable storage medium. Further, any of the processes of the present invention can be implemented in one or more computers or computer systems or other forms of apparatus. Further still, any of the processes of the present invention can be implemented in one or more computer program products. Some embodiments of the present invention provide a computer system or a computer program product that encodes or has instructions for performing any or all of the processes disclosed herein. Such processes/instructions can be stored on a CD-ROM, DVD, magnetic disk storage product, or any other tangible computer readable data or tangible program storage product. Such methods can also be embedded in tangible permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or any other tangible electronic device.

All references cited herein are incorporated herein by reference in their entirety and for all purposes to the same extent as if each individual publication or patent or patent application was specifically and individually indicated to be incorporated by reference in its entirety for all purposes.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A computer-implemented process for compressing a pointer table comprising a plurality of pointers into one or more compressed data structures, the process comprising:
(A) accessing the plurality of pointers, wherein each pointer in the plurality of pointers references an address in a record in a plurality of records stored in computer readable memory;
(B) fitting the plurality of pointers to a fitting function, wherein the fitting function has one or more coefficients, and wherein the fitting comprises establishing a value for each of the one or more coefficients;
(C) building a lookup table, wherein the lookup table comprises, for a pointer in the plurality of pointers, a residual that remains when a value of the fitting function is removed from a value of an address referenced by the pointer; and
(D) storing a representation of the fitting function and the value for each of the one or more coefficients, wherein the one or more compressed data structures comprises the lookup table, the representation of the fitting function, and the value for each of the one or more coefficients.

2. The computer-implemented process of claim 1, wherein the plurality of pointers are stored in a pointer table and wherein the building (C) comprises replacing a value of a pointer in the plurality of pointers in the pointer table with a residual for the respective pointer computed by the building (C) thereby building the lookup table.

3. The computer-implemented process of claim 1, wherein the fitting (B) comprises evaluating a plurality of fitting functions using a subset of the plurality of pointers, wherein the fitting function in the plurality of fitting functions that achieves the most compression of the subset of pointers is deemed to be the fitting function for the plurality of pointers.

4. The computer-implemented process of claim 1, wherein the fitting function is a monomial function, a polynomial function, a rational function, a power function, a power series, or any combination thereof.

5. The computer-implemented process of claim 1, the process further comprising:
(E) receiving a query for an address in a record in the plurality of records, wherein the address is stored in a pointer in the plurality of pointers;
(F) obtaining the residual in the lookup table that corresponds to the pointer;
(G) unpacking the fitting function by obtaining the representation of the fitting function and the value for each of the one or more coefficients of the fitting function that were stored in said storing (D); and
(H) solving the fitting function using the residual from the obtaining (F) and the coefficients of the fitting function from the unpacking (G), thereby obtaining the address in the record in the plurality of records.

6. The computer-implemented process of claim 1, wherein
the fitting (B) further comprises segmenting the plurality of pointers into a plurality of intervals, wherein each interval in the plurality of intervals has independent values for the one or more coefficients of the fitting function; and
the storing (D) further comprises storing a value for each of the one or more coefficients for each interval in the plurality of intervals.

7. The computer-implemented process of claim 6, the process further comprising:
(E) receiving a query for an address in a record in the plurality of records, wherein the address is stored in a pointer in the plurality of pointers;
(F) obtaining a residual in the lookup table that corresponds to the pointer;
(G) determining an interval in the plurality of intervals that corresponds to the pointer;
(H) unpacking the fitting function by obtaining the representation of the fitting function and the value for each of the one or more coefficients of the fitting function that corresponds to the interval identified in the determining (G); and
(I) solving the fitting function using the residual from the obtaining (F) and the coefficients of the fitting function from the unpacking (H), thereby obtaining the address in the record in the plurality of records.

8. The computer-implemented process of claim 7 wherein
a range of pointers covered by a first interval in the plurality of intervals is different than a range of pointers covered by a second interval in the plurality of intervals; and
the determining (G) is a binary search for the interval in the plurality of intervals based on an identity of the pointer in the plurality of pointers.

9. The computer-implemented process of claim 7, wherein each interval in the plurality of intervals corresponds to a fixed range of pointers in the plurality of pointers.

10. The computer-implemented process of claim 1, wherein
the fitting (B) further comprises segmenting the plurality of pointers into a plurality of intervals, wherein each interval in the plurality of intervals has an independent fitting function with one or more coefficients; and
the storing (D) further comprises storing, for each respective interval in the plurality of intervals, a representation of the fitting function and a value for each of the one or more coefficients of the fitting function for the respective interval.

11. The computer-implemented process of claim 1, wherein a first record in the plurality of records has a different size than a second record in the plurality of records.

12. The computer-implemented process of claim 1, wherein a record in the plurality of records is a database record or a document written in a markup language.

13. The computer-implemented process of claim 1, wherein the lookup table comprises the first pointer in the plurality of pointers, the last pointer in the plurality of pointers, and for each respective pointer in the plurality of pointers other than the first pointer and the last pointer in the plurality of pointers, a respective residual that remains when a value of the fitting function is removed from the value of the respective pointer.

14. The computer-implemented process of claim 1, wherein the plurality of pointers are arranged (i) in order of increasing value or (ii) in order of decreasing value.

15. A computer system for compressing a pointer table comprising a plurality of pointers into one or more compressed data structures, comprising:
a main memory;
a processor; and
at least one program, stored in the main memory and executed by the processor, the at least one program including instructions for:
(A) accessing the plurality of pointers wherein each pointer in the plurality of pointers references an address in a record in a plurality of records stored in computer readable memory;
(B) fitting the plurality of pointers to a fitting function, wherein the fitting function has one or more coefficients, and wherein the fitting comprises establishing a value for each of the one or more coefficients;
(C) building a lookup table, wherein the lookup table comprises, for a pointer in the plurality of pointers, a residual that remains when a value of the fitting function is removed from a value of an address referenced by the pointer; and
(D) storing a representation of the fitting function and the value for each of the one or more coefficients, wherein the one or more compressed data structures comprises the lookup table, the representation of the fitting function, and the value for each of the one or more coefficients.

16. A computer-implemented process for compressing an inverted index, the process comprising:
(A) accessing the inverted index, wherein the inverted index comprises a plurality of terms and a plurality of inverted field entries, wherein
each respective term in the plurality of terms corresponds to an inverted field entry in the plurality of inverted field entries,
each respective inverted field entry in the plurality of inverted field entries comprises a list of pointers, and
each pointer in a list of pointers in an inverted field entry corresponding to a respective term in the plurality of terms comprises an address of the respective term in a record in a plurality of records;
(B) fitting a list of pointers in an inverted field entry for a respective term in the plurality of terms to a fitting function, wherein the fitting function has one or more coefficients, and wherein the fitting comprises establishing a value for each of the one or more coefficients;
(C) building a respective lookup table for the list of pointers in the inverted field entry corresponding to the respective term, wherein the respective lookup table comprises, for a pointer in the list of pointers for the inverted field entry corresponding to the respective term, a residual that remains when a value of the fitting function is removed from a value of an address referenced by the pointer;
(D) storing a representation of the fitting function and the value for each of the one or more coefficients for the respective lookup table; and
(E) optionally repeating the fitting (B), the building (C), and the storing (D) for another list of pointers in another inverted field entry corresponding to another term in the plurality of terms in the inverted index.

17. The computer-implemented process of claim 16 wherein the building (C) comprises replacing the value of a pointer in the list of pointers with the residual for the pointer computed by the building (C) thereby building the respective lookup table.

18. The computer-implemented process of claim 16, wherein the fitting (B) comprises evaluating a plurality of fitting functions using a subset of the list of pointers, wherein the fitting function in the plurality of fitting functions that achieves the most compression of the subset of pointers is deemed to be the fitting function for the list of pointers.

19. The computer-implemented process of claim 16, wherein the fitting function is a monomial function, a polynomial function, a rational function, a power function, a power series, or any combination thereof.

20. The computer-implemented process of claim 16, wherein
the fitting (B) further comprises segmenting the list of pointers into a plurality of intervals, wherein each interval in the plurality of intervals has independent values for the one or more coefficients of the fitting function; and
the storing (D) further comprises storing a value for each of the one or more coefficients of the fitting function for each interval in the plurality of intervals.

21. The computer-implemented process of claim 20, the process further comprising:
(F) receiving a query for an address in a record in the plurality of records, wherein the address is stored in a pointer in the list of pointers in the inverted field entry corresponding to a term in the plurality of terms;
(G) obtaining the residual in the lookup table that corresponds to the pointer;
(H) determining which interval in the plurality of intervals corresponds to the pointer;
(I) unpacking the fitting function by obtaining the representation of the fitting function; and the value for each of the one or more coefficients of the fitting function that correspond to the interval identified in the determining (H); and
(I) solving the fitting function using the residual from the obtaining (G) and the coefficients of the fitting function from the unpacking (I), thereby obtaining the address in the record.

22. The computer-implemented process of claim 21 wherein
a range of pointers covered by a first interval in the plurality of intervals is different than a range of pointers covered by a second interval in the plurality of intervals; and
the determining (H) is a binary search for the interval in the plurality of intervals based on an identity of the pointer.

23. The computer-implemented process of claim 22, wherein each interval in the plurality of intervals corresponds to a fixed range of pointers in the plurality of pointers.

24. The computer-implemented process of claim 16, wherein
the fitting (B) further comprises breaking the list of pointers into a plurality of intervals, wherein each interval in the plurality of intervals has an independent fitting function with one or more coefficients; and
the storing (D) further comprises storing, for each respective interval in the plurality of intervals, a representation of the fitting function and a value for each of the one or more coefficients of the fitting function for the respective intervals.

25. The computer-implemented process of claim 16, wherein a first record in the plurality of records has a different size than a second record in the plurality of records.

26. The computer-implemented process of claim 16, wherein a record in the plurality of records is a database record or a document written in a markup language.

27. The computer-implemented process of claim 16, wherein the lookup table comprises the first pointer in the list of pointers, the last pointer in the list of pointers, and for each respective pointer in the list of pointers other than the first pointer and the last pointer in the list of pointers, a respective residual that remains when a value of the fitting function is removed from the value of the respective pointer.

28. The computer-implemented process of claim 16 wherein a plurality of pointers in a list of pointers in an inverted field entry corresponding to a term in the plurality of terms is arranged (i) in order of increasing value or (ii) in order of decreasing value.

29. A computer system for compressing an inverted index, comprising:
a main memory;
a processor; and
at least one program, stored in the main memory and executed by the processor, the at least one program including instructions for:
(A) accessing the inverted index, wherein the inverted index comprises a plurality of terms and a plurality of inverted field entries, wherein
each respective term in the plurality of terms corresponds to an inverted field entry in the plurality of inverted field entries,
each respective inverted field entry in the plurality of inverted field entries comprises a list of pointers, and
each pointer in a list of pointers in an inverted field entry corresponding to a respective term in the plurality of terms comprises an address of the respective term in a record in a plurality of records;
(B) fitting a list of pointers in an inverted field entry for a respective term in the plurality of terms to a fitting function, wherein the fitting function has one or more coefficients, and wherein the fitting comprises establishing a value for each of the one or more coefficients;
(C) building a respective lookup table for the list of pointers in the inverted field entry corresponding to the respective term, wherein the respective lookup table comprises, for a pointer in the list of pointers for the inverted field entry corresponding to the respective term, a residual that remains when a value of the fitting function is removed from a value of an address referenced by the pointer;
(D) storing a representation of the fitting function and the value for each of the one or more coefficients for the respective lookup table; and
(E) optionally repeating the fitting (B), the building (C), and the storing (D) for another list of pointers in another inverted field entry corresponding to another term in the plurality of terms in the inverted index.

30. A computer-implemented process for processing a search query, the process comprising:
(A) receiving said search query;
(B) executing a search for documents with said search query thereby obtaining a search result wherein the search for documents comprises the process of:
(i) accessing an inverted index, wherein the inverted index comprises a plurality of terms and a plurality of lookup tables, wherein each respective term in the plurality of terms corresponds to a lookup table in the plurality of lookup tables, each lookup table in the plurality of lookup tables comprising a plurality of residuals, each residual in the plurality of residuals corresponding to an address of a document in a plurality of documents;
(ii) identifying a lookup table in the inverted index corresponding to a term in the plurality of terms that matches a term in the search query;
(iii) obtaining a residual in the lookup table identified in (ii);
(iv) unpacking a fitting function and a value for each of a plurality of coefficients of the fitting function for the lookup table identified in (ii);
(v) solving the fitting function using the residual from the obtaining (iii) and the plurality of coefficients of the fitting function from the unpacking (iv), thereby obtaining the address of a document in the plurality of documents; and
(vi) adding the document from the solving (v) to an output search result using the address obtained in the solving (v); and
(C) outputting the output search result to a user in user readable form, a user interface device, a monitor, a tangible computer readable storage medium, a computer readable memory, a local computer system, or a remote computer system.

31. The computer-implemented process of claim 30, wherein the fitting function is a monomial function, a polynomial function, a rational function, a power function, a power series, or any combination thereof.

32. The computer-implemented process of claim 30, wherein document is compressed.

33. The computer-implemented process of claim 30, wherein the document is a static graphic representation of a document found on the Internet during a crawl.

34. The computer-implemented process of claim 30, wherein a first document in the plurality of documents has a different size than a second document in the plurality of documents.

35. The computer-implemented process of claim 30, wherein the document is a database record or a document written in a markup language.

36. The computer-implemented process of claim 30, wherein the lookup table comprises the first pointer in a plurality of pointers, the last pointer in a plurality of pointers, and for each respective pointer in the plurality of pointers other than the first pointer and the last pointer in the plurality of pointers, a respective residual that remains when a value of the fitting function is removed from the value of the respective pointer.

37. A computer system for processing a search query, the computer system comprising:
a main memory;
a processor; and
at least one program, stored in the main memory and executed by the processor, the at least one program including instructions for:
(A) receiving said search query;
(B) executing a search for documents with said search query thereby obtaining a search result wherein the search for documents comprises the process of:
(i) accessing an inverted index, wherein the inverted index comprises a plurality of terms and a plurality of lookup tables, wherein each respective term in the plurality of terms corresponds to a lookup table in the plurality of lookup tables, each lookup table in the plurality of lookup tables comprising a plurality of residuals, each residual in the plurality of residuals corresponding to an address of a document in a plurality of documents;
(ii) identifying a lookup table in the inverted index corresponding to a term in the plurality of terms that matches a term in the search query;
(iii) obtaining a residual in the lookup table identified in (ii);
(iv) unpacking a fitting function and a value for each of a plurality of coefficients of the fitting function for the lookup table identified in (ii);
(v) solving the fitting function using the residual from the obtaining (iii) and the plurality of coefficients of the fitting function from the unpacking (iv), thereby obtaining the address of a document in the plurality of documents; and
(vi) adding the document from the solving (v) to an output search result using the address obtained in the solving (v); and
(C) outputting the output search result to a user in user readable form, a user interface device, a monitor, a tangible computer readable storage medium, a computer readable memory, a local computer system, or a remote computer system.

38. A computer-implemented process for compressing a plurality of integers, the process comprising:
(A) accessing the plurality of integers, wherein each integer in the plurality of integers references an address in a record in a plurality of records stored in computer readable memory;
(B) fitting the plurality of plurality of integers to a fitting function, wherein the fitting function has a plurality of coefficients, and wherein the fitting comprises establishing a value for each coefficient in the plurality of coefficients;
(C) building a lookup table, wherein the lookup table comprises, for each integer in the plurality of integers, other than the first integer and the last integer in the plurality of integers, a residual that remains when a value of the fitting function is removed from the value of the integer; and
(D) storing a representation of the fitting function, the value for each of the one or more coefficients, and the lookup table, thereby compressing the plurality of integers.

39. The computer-implemented process of claim 38, wherein the fitting (B) comprises evaluating a plurality of fitting functions using a subset of the plurality of integers, wherein the fitting function in the plurality of fitting functions that achieves the most compression of the subset of integers is deemed to be the fitting function for the plurality of integers.

40. The computer-implemented process of claim 38, wherein the fitting function is a monomial function, a polynomial function, a rational function, a power function, a power series, or any combination thereof.

41. The computer-implemented process of claim 38, the process further comprising:
(E) receiving a query for an address in a record in the plurality of records, wherein the address is stored in an integer in the plurality of integers;
(F) obtaining the residual in the lookup table that corresponds to the integer;
(G) unpacking the fitting function by obtaining the representation of the fitting function and the value for each of the plurality of coefficients of the fitting function that were stored in said storing (D); and
(H) solving the fitting function using the residual from the obtaining (F) and the coefficients of the fitting function from the unpacking (G), thereby obtaining the address in the record in the plurality of records.

42. The computer-implemented process of claim 38, wherein
the fitting (B) further comprises segmenting the plurality of integers into a plurality of intervals, wherein each interval in the plurality of intervals has independent values for the plurality of coefficients of the fitting function; and
the storing (D) further comprises storing the value for each of the plurality of coefficients for each interval in the plurality of intervals.

43. The computer-implemented process of claim 42, the process further comprising:
(E) receiving a query for an address in a record in the plurality of records, wherein the address is stored in an integer in the plurality of integers;
(F) obtaining the residual in the lookup table that corresponds to the integer;
(G) determining which interval in the plurality of intervals corresponds to the integer;
(H) unpacking the fitting function by obtaining the representation of the fitting function; and the value for each of the one or more coefficients of the fitting function that correspond to the interval identified in the determining (G); and
(I) solving the fitting function using the residual from the obtaining (F) and the coefficients of the fitting function from the unpacking (H), thereby obtaining the address in the record in the plurality of records.

44. The computer-implemented process of claim 43 wherein
a range of integers covered by a first interval in the plurality of intervals is different than a range of integers covered by a second interval in the plurality of intervals; and
the determining (G) is a binary search for the interval in the plurality of intervals based on an identity of the integer in the plurality of integers.

45. The computer-implemented process of claim 43, wherein each interval in the plurality of intervals corresponds to a fixed range of integers in the plurality of integers.

46. The computer-implemented process of claim 38, wherein
the fitting (B) further comprises segmenting the plurality of integers into a plurality of intervals, wherein each interval in the plurality of intervals has an independent fitting function with a plurality of coefficients; and
the storing (D) further comprises storing, for each respective interval in the plurality of intervals, a representation of the fitting function and a value for each coefficient in the plurality of coefficients of the fitting function for the respective interval.

47. The computer-implemented process of claim 38, wherein the lookup table comprises the first integer in the plurality of integers, the last integer in the plurality of integers, and for each respective integer in the plurality of integers other than the first integer and the last integer in the plurality of integers, a respective residual that remains when a value of the fitting function is removed from the value of the respective integer.

48. The computer-implemented process of claim 38, wherein the plurality of integers are arranged (i) in order of increasing value or (ii) in order of decreasing value.

49. A computer system for compressing a plurality of integers, the computer system comprising:
a main memory;
a processor; and
at least one program, stored in the main memory and executed by the processor, the at least one program including instructions for:
(A) accessing the plurality of integers, wherein each integer in the plurality of integers references an address in a record in a plurality of records stored in computer readable memory;
(B) fitting the plurality of plurality of integers to a fitting function, wherein the fitting function has a plurality of coefficients, and wherein the fitting comprises establishing a value for each coefficient in the plurality of coefficients;
(C) building a lookup table, wherein the lookup table comprises, for each integer in the plurality of integers, other than the first integer and the last integer in the plurality of integers, a residual that remains when a value of the fitting function is removed from the value of the integer; and
(D) storing a representation of the fitting function, the value for each of the one or more coefficients, and the lookup table, thereby compressing the plurality of integers.
